(19) United States
(12) Patent Application Publication
(10) Pub. No.: US 2006/0101879 A1
(43) Pub. Date: May 18, 2006

(54) Operating device for a lock for doors or bonnets on a motor vehicle

(76) Inventor: Mensur Velicanin, Velbert (BA)

Correspondence Address: FRIEDRICH KUEFFNER, 317 MADISON AVENUE, SUITE 910, NEW YORK, NY, 10017, US

(21) Appl. No.: 10/538,968

(22) PCT Filed: Oct. 25, 2003
(86) PCT No.: PCT/EP03/11888

§ 371 Date: Jun. 14, 2005

(30) Foreign Application Priority Data
Dec. 19, 2002 (DE) 102 60 076.7

(51) Int. Cl. E05B 17/04

(52) U.S. Cl. 70/379 R; 70/337

(57) ABSTRACT

A shaft (20) bridges the axial separation between a locking cylinder (10) and a lock (15). In order to also compensate for a radial offset (18, 19) between the locking cylinder and the lock (15), said shaft (20) must be flexible. According to the invention, an economical reliable shaft (20) may be developed, whereby said shaft has a one-piece embodiment in a flexible material and a series of notches (25, 25′) running perpendicular to the shaft axis (14) provided therein. In the notched region, a web (27) remains in the shaft (20) between the two edges of the notches (25, 25′). Said notches (25, 25′) are let into the shaft (20) from two differing directions (21, 22). The web (27) thus functions as a flexing point as the both edges of the notches (25, 25′) may be displaced towards or away from each other on application of flexing loads.

The invention pertains to an actuating device of the type indicated in the introductory clause of claim 1. Whereas the end surface of the lock cylinder remains accessible to the key from the outside, the lock is located inside the door. The lock cylinder consists of a key-actuated rotor, which is rotatably supported in a stationary stator in the door. The shaft cited in the introductory clause of claim 1 has the task of transmitting the torque exerted on the rotor of the lock cylinder to the lock elements. It often happens that the axis of the rotor in the cylinder rotor is not only a certain axial distance away from the axis of rotation around which the lock elements are actuated but also radially offset from it.

An actuating device is known (DE 195 27 837 C2), in which the shaft consists of a rigid rod with joint parts at both ends, which are components of two universal joints, namely, one oriented toward the rotor on the cylinder side and one oriented toward the lock elements. If the locations of the lock and of the lock cylinder are predetermined, there is only one course which the straight shaft can take in the interior of the door. A shaft taking this course, however, can collide with door elements located along its path or interfere with the installation and removal of door elements or lock elements.

More favorable in this regard is a device of the type indicated in the introductory clause of claim 1 (FR 1 175 848 or DE 196 49 905 C2). Here a flexible shaft is used, which can assume any arc-like shape as it passes between the axis of the lock cylinder and the axis of the lock elements. This known shaft consists of a wire bent into the form of a helix. To increase the flexibility of the shaft, the wire must be thinner and/or more flexible wire material must be used. This can lead to torque slippage between the two ends of the wire helix when torque is being transmitted. This is especially true when the torques must be transmitted in opposition to considerable rotational resistance.

In the case of a tubular longitudinal element which is used to transmit forces (EP 0 889 252 A2), it is known that only single cuts can be made in the tube wall, alternating from side to side, as a result of which a segment of a circle remains in the opposite tube wall. Such segments of a circle do not give the tubular body good flexibility. There is no cross section extending down the entire axis of the tube which continues axially past all of the cut-ins. The use of the tubular body with cuts on one side for a shaft connecting a lock cylinder to a lock of the type indicated in the introductory clause of claim 1 is problematic. A driver for actuating the lock at one end of the tube and a connection for the lock cylinder at the other end of the tube cannot be fastened to the tubular body without taking additional measures.

The invention is based on the task of developing a low-cost, reliable device of the type indicated in the introductory clause of claim 1, which improves the transmission of torque and the flexibility of the shaft. This is achieved according to the invention by means of the measures indicated in claim 1, to which the following special meaning attaches.

Each pair of notches cut into the shaft from opposite sides leads to the formation of a web near the axis of the shaft. The length of this web extends essentially over the entire diameter of the shaft. This is favorable to the transmission of torque. Because the notches are cut into the shaft from diametrically opposing sides, a core extending down the axis of the shaft remains between the webs, which core promotes good flexibility as do the flanks of the paired notches, which flanks are essentially parallel to each other and extend radially with respect to the shaft axis. That is, when bending load is exerted on the shaft, these parallel flanks can move toward and away from each other, as a result of which it is possible to provide the flexible inventive shaft with small bending radii. Flexible shafts of this type can be made very easily out of flexible plastic and can be produced easily by the injection-molding process. The special economy of the device, however, is a result of the fact that both a driver for actuating the lock and a connection for the lock cylinder can be produced simultaneously, as integral parts, at the ends of the flexible inventive shaft during the injection-molding process. There is therefore no longer any need to produce these terminal elements separately and to attach them to the shaft, which is time-consuming.

Additional measures and advantages of the invention can be derived from the subclaims, from the following description, and from the drawings. The drawings illustrate the invention on the basis of an exemplary embodiment:

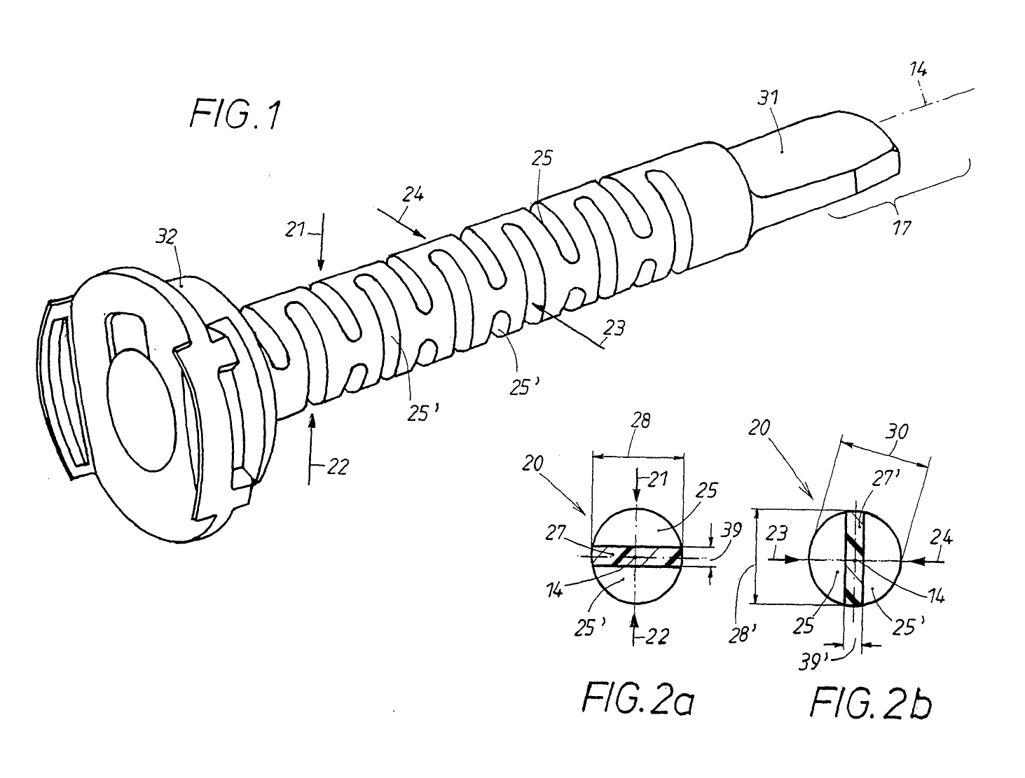

FIG. 1 shows an enlarged, perspective view of the inventive shaft, where a connection for the lock cylinder and a driver for actuating the lock have also been molded onto the shaft;

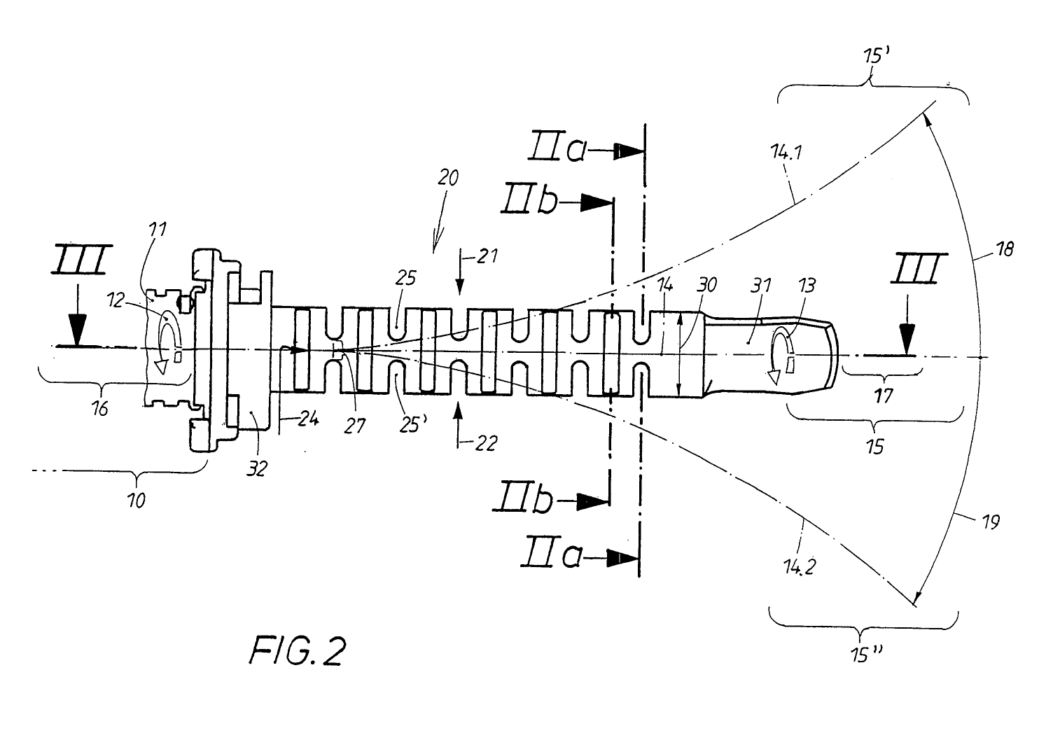

FIG. 2 shows a plan view of the shaft according to FIG. 1;

FIGS. 2a and 2b show two cross sections through the shaft of FIG. 2 along the lines IIa-IIa and IIb-IIb in that figure; and

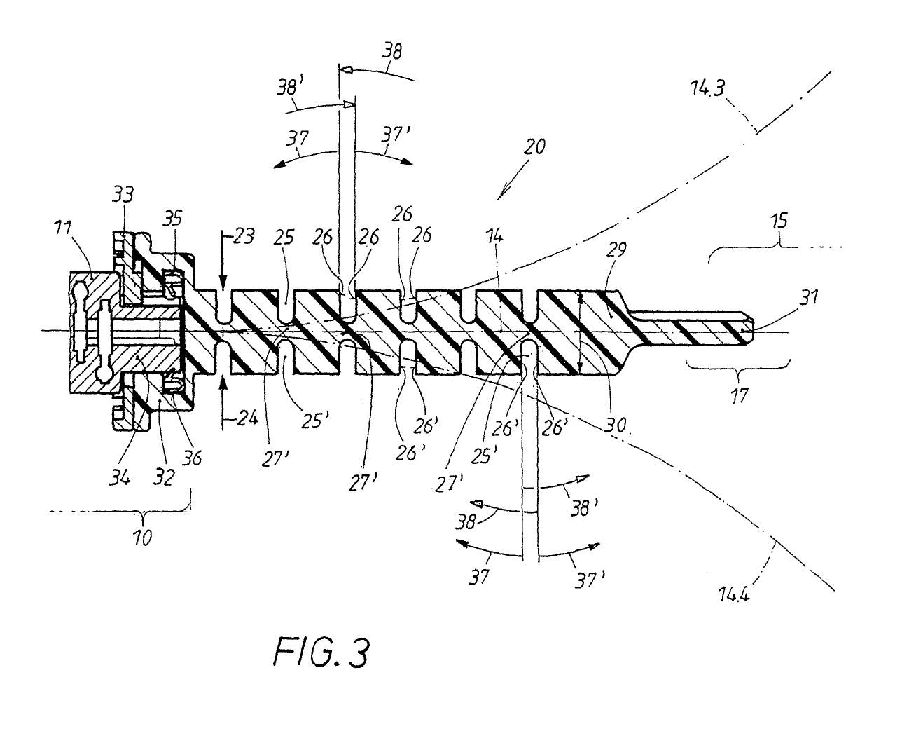

FIG. 3 shows a longitudinal cross section through the shaft of FIG. 2 along line III-III in that figure.

Reference is made first to FIG. 2. A special shaft 20 extends between a lock cylinder 10, only a part of the rotor 11 of which is shown, and lock elements located at 15 (not shown). The shaft 20 is able to transmit an input torque, illustrated by the arrow of rotation 12, to an output torque 13, illustrated by the arrow 13. The shaft 20 is shown in the straight, stretched-out state in all the figures, which is expressed by the straight course of the shaft axis 14. In this case, the rotor shaft 16 is axially aligned with the shaft output 17. When the lock elements 15 assume positions 15′, 15″ which are not only a certain axial distance away but also radially offset from the rotor shaft 16, the shaft 20 can be bent out of the straight, stretched-out position 14 around the angle 18 or 19 into one of the curved positions 14.1-14.4 in any of the four directions 21-24, as can be seen FIGS. 2 and 3. The shaft 20 therefore has the task not only of bridging the axial distance between the lock cylinder 10 and the lock 15 or 15′ or 15″ but also of compensating for a radial offset 18, 19 of the lock elements 15′, 15″ from the rotor axis 16 and the corresponding shaft output. For this purpose, the shaft is designed in the following manner.

The shaft 20 consists of flexible material 29. Notches 25, 25′ are recessed into the shaft 20 from each of the four sides 21-24, which are at right angles to each other. Namely, one pair 25, 25′ of these notches is introduced from two diametrically opposing sides 21, 22, and another pair 25, 25′ from the other set of opposing sides 23, 24. The notches 25, 25′ are perpendicular to the straight, stretched-out shaft axis 14 and have flanks 26, 26 and 26′, 26′, respectively, which are essentially parallel to each other.

As can be seen from the cross-sectional views of FIGS. 2a and 2b, webs 27, 27′, which are perpendicular to each other, are formed between the notch pairs 25, 25′. The webs 27, 27′ are located near the shaft axis 14 and have a flat profile. As a result, the webs 27, 27′ have a radial length 28, 28′, which is practically the same as the diameter 30 of the shaft 20. Intermediate axial pieces 40, which have the full cross section of the shaft, remain between the successive pairs of notches 25, 25′, which alternate between diametrically opposing sides 21, 22 and 23, 24.

Elements of the same plastic material 29 are molded integrally onto the two ends of the shaft, the element at one end cooperating with the rotor 11, the element at the other end cooperating with the lock 5. Thus, at the inner end of the shaft, a driver 31 is provided for the actuation of the lock 15. It has the form of a paddle. At the outer end of the shaft is a connection 32 for the cylinder core 11 of the lock cylinder 10. The connection 32 has the form of a housing shell. An overload element 33, which is connected nonrotatably to the output 34 of the rotor 11, is integrated into the housing shell of this connection 32. The rotor output 34 is also connected to the housing connection 32 in a manner which allows no axial movement. A spring ring 35, which can be seen in FIG. 3, is used for this purpose. It engages in an undercut annular groove 36. The connection between the overload element 23 and the connection 32, however, is also nonrotatable when the previously mentioned torque 12, which is always below a specific threshold, is exerted on the rotor 11 via the inserted key. When the shaft 20 is manipulated by a break-in tool, this threshold value is exceeded, and the overload element 33 becomes freewheeling with respect to the connection 32. As a result, forcible rotation of the rotor 11 is not transmitted to the shaft 20.

The webs 27, 27′ ensure the good flexibility of the shaft 20 and function as flex points, which can be seen clearly in FIG. 3. As FIGS. 2a and 2b show, the webs 27, 27′ are relatively thin 39, 39′. A bending load on the shaft in the direction of the bending line 14.4 results because the flanks 26 of the notches 25 move away from each other in the direction of the arrows 37, 37′. The flanks 26 of the webs 27′ in effect swing open. The opposite movements occur at the diametrically opposite notch 25′. Here, when the shaft bends as indicated by the bending line 14.4 of FIG. 3, the two flanks 26′, 26′ swing toward each other in the direction of the arrows 38, 38′. The web 27′ acts like a “film hinge”.

Nevertheless, the flat profile 28, 39; 28′, 39′ of the two webs 27, 27′ is sufficient to transmit the previously mentioned torques 12 applied to the rotor 11 to the shaft output 17. The output torque 13 is essentially the same as the input torque 12. There is no torsional slippage of the shaft 20, because the webs have been provided with the maximum possible length 28, 28′.

When bending load is exerted on the shaft 20 to produce the bending line 14.3 of FIG. 3, the relationships present at the flanks 26, 26′ of the two notches 25, 25′ are the mirror images of those just described. The notch flanks 26 swing toward each other in the direction of the arrows 38, 38′ of FIG. 3, whereas the opposite notch flanks 26′, 26′ swing away from each other in the direction of the arrows 37, 37′. The corresponding movements occur when the bending loads occur in the directions of the two other bending lines 14.1 and 14.2 of FIG. 2.

### LIST OF REFERENCE NUMBERS

10 lock cylinder
11 rotor
12 input torque of 20
13 output torque of 20
14 axis of shaft 20
14.1 curved course of 14 in direction 21 (FIG. 2)
14.2 curved course of 14 in direction 22 (FIG. 2)
14.3 curved course of 14 in direction 23 (FIG. 3)
14.4 curved course of 14 in direction 24 (FIG. 3)
15 position of the lock elements, aligned (FIG. 2)
15′ position of 15, offset upward (FIG. 2)
15″ position of 15, offset downward (FIG. 2)
16 shaft of rotor 11
17 output of shaft 20, inner end of 14
18 first angle of 14′ from 14 (FIG. 2)
19 second angle of 14″ from 14 (FIG. 2)
20 shaft
21 top side of 20 for 25
22 bottom side of 20 for 25′
23 left side of 20 for 25
24 right side of 20 for 25′
25, 25′ notches in 21, 23 and 22, 24, respectively
26, 26′ flanks of 25 and 25′, respectively
27, 27′ webs between 25, 25 and 25′, 25′, respectively
28 radial length of 27, flat profile of 27
28′ radial length of 27′, flat profile of 27′
29 flexible plastic material of 20
30 diameter of 20
31 driver on 20 for 15
32 connection on 20 for 11
33 overload element at 32
34 output of 11
35 spring ring at 34 (FIG. 3)
36 annular groove in 32 (FIG. 3)
37, 37′ arrow of the swing-out movement of 26, 26′ (FIG. 3)
38, 38′ arrow of the swing-in movement of 26, 26′ (FIG. 3)
39, 39′ thickness of 27, 27′, flat profile
40 intermediate axial piece of 20

1. Actuating device for a lock in a door or hatch of a motor vehicle,
with a lock cylinder (10), which has a lock (15) located a certain axial distance away and a shaft (20) extending between it and the lock;
which shaft transmits (13) a torque (12) to the lock (15) when the lock cylinder (10) is rotated;
where the shaft (20) is flexible (14.1-14.4) in its axial direction (14) to compensate for a radial offset (18, 19) between the axis (16) of the lock cylinder (10) and the lock (15), wherein
the one-piece shaft (20) is made of flexible material (29) and has a family of notches (25, 25′) extending transversely to the axis (14) of the shaft;
which notches are recessed in pairs (25, 25′) into the shaft (20) from diametrically opposing sides (21, 22 and 23, 24); in that
when the shaft (20) is stretched out straight, the two flanks (26, 26; 26′, 26′) of the notches (25, 25′) are essentially parallel to each other and extend radially with respect to the axis (14) of the shaft; wherein
the notch pairs (25, 26′) leave a web (27, 27′) in the shaft (20) between their flanks (26, 26; 26′, 26′);
which web is located on the axis (14) of the shaft and extends essentially across the entire diameter (30) of the shaft (20); wherein
the webs (27, 27′) produce flex points, at which, when bending load is exerted on the shaft (20), the two flanks (26, 26; 26′, 26′) of the notch pairs (25, 25′) can swing toward (38, 38′) or away (37, 37′) from each other; wherein
intermediate axial pieces (40), extending in the axial direction (14) of the shaft and with the full cross section of the shaft (40), remain between successive pairs of diametrically opposing notches (25, 25′); and wherein
a driver (31) for actuating the lock (15 or 15′ or 25″) and/or a connection (32) for the lock cylinder (10) is formed integrally on the shaft (20).

2. Device according to claim 1, wherein the driver (31) has the form of a paddle.

3. Device according to claim 1, wherein an overload element (33) is integrated into the connection (32),
which overload element, when the lock cylinder (10) is actuated as normal by the key, ensures a nonrotatable connection between the cylinder core (11) and the connection (32) at the outer end of the shaft (20), but also wherein,
when the lock cylinder (10) is actuated forcibly by means of a break-in tool, as a result of which a specific torque limit is exceeded, the overload element (33) lets the cylinder core (11) and the driver (31) for the lock (15) rotate freely with respect to each other.
